(19) United States
(12) Patent Application Publication
(10) Pub. No.: US 2009/0102289 A1
(43) Pub. Date: Apr. 23, 2009

(54) Techniques for Selecting a Voltage Source From Multiple Voltage Sources

(76) Inventors: Anthony G. Aipperspach, Rochester, MN (US); David E. Schmitt, Rochester, MN (US)

Correspondence Address: IBM CORPORATION, 3605 HIGHWAY 52 NORTH, DEPT 917, ROCHESTER, MN, 55901-7829, US

(21) Appl. No.: 11/874,470

(22) Filed: Oct. 18, 2007

(51) Int. Cl. H02J 1/00

(52) U.S. Cl. 307/80

(57) ABSTRACT

A technique for selecting a voltage source from multiple voltage sources includes receiving a first voltage at an input of a first inverter, which includes a first supply node coupled to a second voltage and a second supply node coupled to a common node. The second voltage is received at an input of a second inverter, which includes a third supply node coupled to the first voltage and a fourth supply node coupled to the common node. An output of the first inverter is coupled to the input of the second inverter and an output of the second inverter is coupled to the input of the first inverter. One of the first and second voltages is provided at an output node based on respective signal levels at the outputs of the first and second inverters.

### BACKGROUND

1. Field

This disclosure relates generally to voltage sources and, more specifically to techniques for selecting a voltage source from multiple voltage sources.

2. Related Art

In most complementary metal-oxide semiconductor (CMOS) circuit designs that employ multiple voltage sources (e.g., two voltage sources), voltage levels provided by the multiple voltage sources are known. That is, by definition, it is known which of the voltage sources has a higher voltage level. In various CMOS circuit designs, a standard level shifter has been employed to shift from a first domain (at a first voltage level) to a second domain (at has a second voltage level) that is at a higher voltage level than the first domain. However, in some circuit designs that employ multiple voltage sources and multiple operation modes, it is not known a priori which of the multiple voltages sources has a higher voltage level.

For example, in circuit designs that employ different operation modes, voltage sources may change voltage levels and a first voltage source that has a higher voltage level than a second voltage source in a first operation mode may have a lower voltage level than the second voltage source in a second operation mode. As such, a single voltage source cannot be selected to continuously power a level shifter, as a voltage level provided by the single voltage source to power the level shifter may in some cases be lower than a voltage level provided to an input of the level shifter. In this case, for example, downstream p-channel field-effect transistors (FETs) may not fully turn off and downstream n-channel FETs may not fully turn on.

### SUMMARY

According to various aspects of the present disclosure, a technique for operating a voltage selection circuit includes receiving a first voltage at an input of a first inverter of the voltage selection circuit. The first inverter includes a first supply node coupled to a second voltage and a second supply node coupled to a common node. The second voltage is received at an input of a second inverter of the voltage selection circuit. The second inverter includes a third supply node coupled to the first voltage and a fourth supply node coupled to the common node. An output of the first inverter is coupled to the input of the second inverter and an output of the second inverter is coupled to the input of the first inverter. One of the first and second voltages is provided at an output node of the voltage selection circuit, based on respective signal levels at the outputs of the first and second inverters. In this manner, an appropriate one of multiple voltage sources may be provided to power another circuit, even when voltage levels provided by the multiple voltage sources change in different operation modes.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is an electrical diagram of a voltage selector circuit that is configured to select a voltage, according to various aspects of the present disclosure, to power a circuit.

FIG. 2 is a signal diagram depicting various signals of interest associated with the circuit of FIG. 1, when a first voltage (VPRG), provided by a first voltage source, is greater than a second voltage (VDD), provided by a second voltage source.

FIG. 3 is a signal diagram depicting various signals of interest associated with the circuit of FIG. 1, when the second voltage is greater than the first voltage.

FIG. 4 is an electrical diagram of a voltage selector circuit that is configured to select a voltage, according to various aspects of the present disclosure, to power another circuit.

FIG. 5 is a signal diagram depicting various signals of interest associated with the circuit of FIG. 4, when a first voltage (VPRG), provided by a first voltage source, is greater than a second voltage (VDD), provided by a second voltage source.

FIG. 6 is a signal diagram depicting various signals of interest associated with the circuit of FIG. 4, when the second voltage is greater than the first voltage.

### DETAILED DESCRIPTION

As will be appreciated by one of ordinary skill in the art, the present invention may be embodied as a method, system, device, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” The present invention may, for example, take the form of a computer program product on a computer-usable storage medium having computer-usable program code, e.g., in the form of one or more design files, embodied in the medium.

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. As used herein, the term “coupled” includes both a direct electrical connection between blocks or components and an indirect electrical connection between blocks or components achieved using intervening blocks or components.

According to various aspects of the present disclosure, a voltage selection circuit is configured to select a voltage source (with a highest voltage level) to power a circuit, e.g., a level shifter. While the disclosure herein is directed to choosing between two voltage sources that have different voltage levels, it is contemplated that the techniques described herein may be extended to selecting a voltage source from among more than two voltage sources. Moreover, it is contemplated that the techniques disclosed herein may be extended to selecting a voltage source to power circuits other than a level shifter, as well as to applications where a lower level voltage source is selected to power a circuit.

According to one aspect of the present disclosure, a technique for operating a voltage selection circuit includes receiving a first voltage (e.g., VDD) at an input of a first inverter of the voltage selection circuit. The first inverter includes a first supply node coupled to a second voltage (e.g., VPRG) and a second supply node coupled to a common node. The second voltage is received at an input of a second inverter of the voltage selection circuit. The second inverter includes a third supply node coupled to the first voltage and a fourth supply node coupled to the common node. An output of the first inverter is coupled to the input of the second inverter and an output of the second inverter is coupled to the input of the first inverter. One of the first and second voltages is provided at an output node of the voltage selection circuit based on respective signal levels at the outputs of the first and second inverters.

According to another aspect of the present disclosure, a voltage selection circuit includes a first inverter, a second inverter, and a selection circuit. The first inverter includes an input coupled to a first voltage node, a first supply node coupled to a second voltage node, and a second supply node coupled to a common node. The first voltage node is configured to receive a first voltage and the second voltage node is configured to receive a second voltage. The second inverter includes an input coupled to the second voltage node, a third supply node coupled to the first voltage node, and a fourth supply node coupled to the common node. An output of the first inverter is coupled to the input of the second inverter and an output of the second inverter is coupled to the input of the first inverter. The selection circuit includes a first input coupled to the output of the second inverter and a second input coupled to the output of the first inverter. The selection circuit is configured to couple one of the first and second voltage nodes to an output node based on signal levels at the outputs of the first and second inverters.

According to one embodiment of the present disclosure, a voltage selection circuit includes a first inverter, a second inverter, a first switch, and a second switch. The first inverter includes an input coupled to a first voltage node, a first supply node coupled to a second voltage node, and a second supply node coupled to a common node. The first voltage node is configured to receive a first voltage and the second voltage node is configured to receive a second voltage. The second inverter includes an input coupled to the second voltage node, a third supply node coupled to the first voltage node, and a fourth supply node coupled to the common node. An output of the first inverter is coupled to the input of the second inverter and an output of the second inverter is coupled to the input of the first inverter. The first switch includes a control terminal, a first terminal, and a second terminal. The control terminal of the first switch is coupled to the output of the second inverter, the first terminal of the first switch is coupled to the second voltage node, and the second terminal of the first switch is coupled to an output node. The second switch includes a control terminal, a first terminal, and a second terminal. The control terminal of the second switch is coupled to the output of the first inverter, the first terminal of the second switch is coupled to the first voltage node, and the second terminal of the second switch is coupled to the output node. The first switch is configured to couple the second voltage node to the output node when the second voltage is greater in magnitude than the first voltage and the second switch is configured to couple the first voltage node to the output node when the first voltage is greater in magnitude than the second voltage.

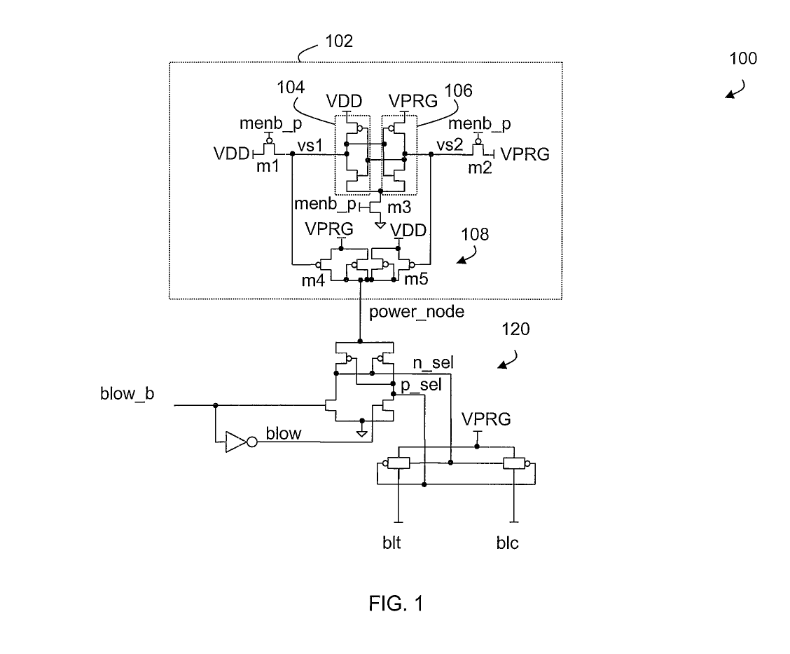

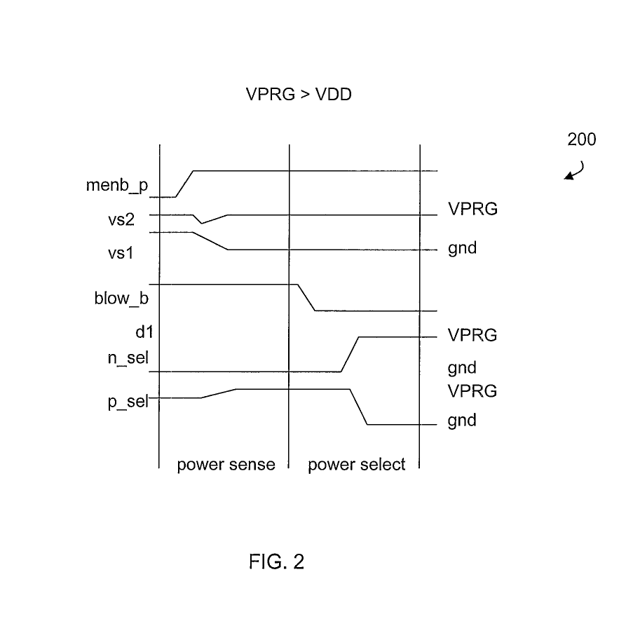

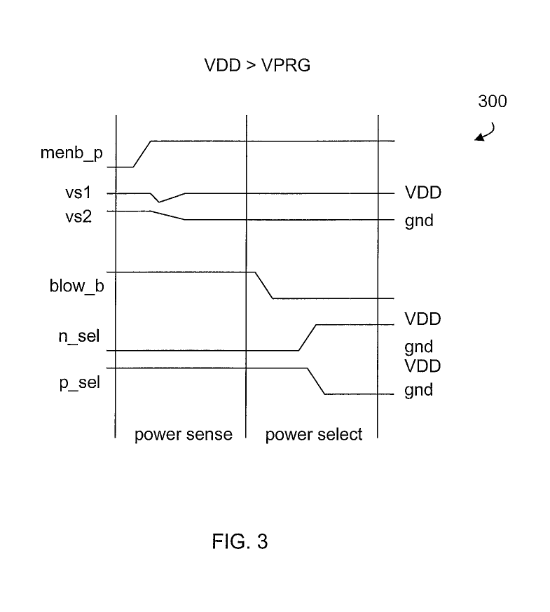

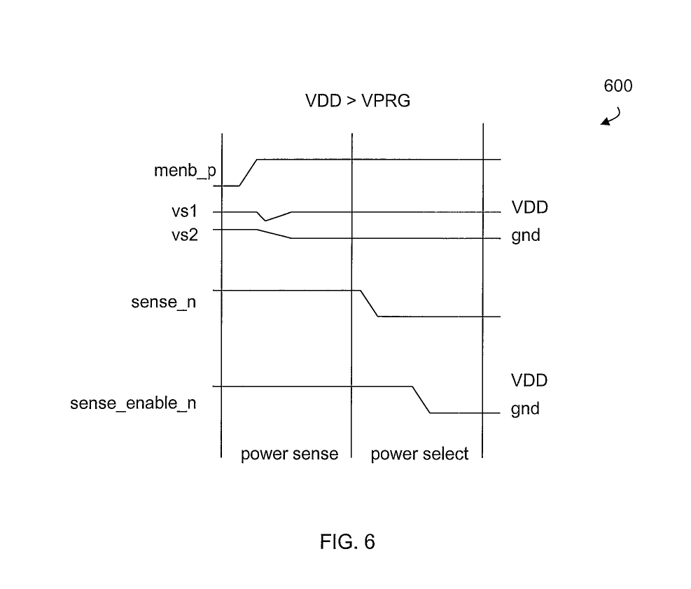

With reference to FIG. 1, a circuit 100 is depicted that includes a voltage selection circuit 102, that is configured according to the present disclosure. The circuit 102 is configured to determine which of two voltage sources has a higher voltage level and provide the selected voltage source with the higher voltage level at an output node (power_node). For example, in a normal operation mode voltage source VPRG has a lower voltage level (typically zero volts) than voltage source VDD. In this case, the circuit 102 provides the voltage source VDD at the output node (see signal diagram 300 of FIG. 3 and signal diagram 600 of FIG. 6). As another example, in a fuse blowing operation mode, the voltage source VPRG has a higher voltage level than the voltage source VDD. In this case, when the fuse blowing portion of circuit 120 is enabled (i.e., when an appropriate signal is provided on a signal line (blow_b), see FIG. 2), the circuit 120 is configured to provide a blow voltage to one or more fuses of an integrated circuit (IC) and the circuit 102 provides the voltage source VPRG on the output node.

In various operation modes, the circuit 102 selects a maximum voltage, which corresponds to either a first voltage source (e.g., VDD) or a second voltage source (e.g., VPRG), from among multiple voltage sources. The selected voltage source is then provided on the output node.

As is illustrated in FIG. 1, the first and second voltage sources (VDD and VPRG) are provided to respective inputs (via p-channel FET pass switches (m1 and m2)) of the circuit 102. More specifically, the pass switches (m1 and m2) are selectively controlled by a control signal (menb_p), which is used to set the inputs of a sense amplifier (including cross-coupled inverters 106 and 104). For the voltage selection circuit 102 to properly operate, it should be appreciated that the voltage levels of VDD and VPRG (or at least the relationship of VDD and VPRG) should not change when the control signal (menb_p) is high (see FIGS. 2 and 3). With reference to FIG. 2, signal diagram 200 illustrates that when the control signal (menb_p) is high and VPRG is greater than VDD, vs1 goes low (e.g., to ground) and vs2 goes to VPRG. Similarly, signal diagram 300 of FIG. 3 illustrates that when the control signal (menb_p) is high and VDD is greater than VPRG, vs1 goes to VDD and vs2 goes low (e.g., to ground).

As mentioned above, the inputs (VDD and VPRG) provided via the pass switches (m1 and m2) drive the inputs of the cross-coupled inverters 106 and 104, respectively. According to various aspects of the present disclosure, the inverter 106 has VDD as its input and utilizes VPRG as its supply (power supply) and the inverter 104 has VPRG as its input and utilizes VDD as its supply. In the disclosed embodiment, both of the inverters 104 and 106 share an n-channel FET footer (m3). When the control signal (menb_p) is low, the footer (m3) is off. In this case, the outputs of the inverters 104 and 106 are incapable of transitioning to a low state. When the control signal (menb_p) is low, the pass gates (m1 and m2) conduct and setup voltages on the inputs of the inverters 106 and 104. The sense amplifier sets when the control signal (menb_p) transitions to a high state.

When the control signal (menb_p) is in a high state, the pass switches (m1 and m2) are non-conductive and the footer (m3) conducts. When the footer (m3) is turned on, the inverters (106 and 104) are activated and the sense amplifier evaluates. In this case, an output of the cross-coupled inverter with the highest voltage supply provides a high level signal (corresponding to an associated supply level) on its output, which turns off an associated one of p-channel FETs (m4 or m5) in selection circuit 108. An output of the cross-coupled inverter with the lower voltage supply provides a low level signal (e.g., ground) on its output, which turns on an associated one of p-channel FETs (m5 or m4) in the selection circuit 108.

In this manner, the selection circuit 108 of the circuit 102, based on the signal levels at the output of the inverters 104 and 106, selects between the two supply sources (VDD and VPRG). In the disclosed embodiment, the selection circuit 108 includes four p-channel FETs. In most cases, before the control signal (menb_p) goes high, the circuit 102 provides the higher of the two source voltages (VDD and VPRG) at the output node. However, when the two voltage sources (VDD and VPRG) are within a p-channel FET threshold voltage (VT) drop of each other, both of the p-channel FETs (m4 and m5), whose control terminals (gates) are connected to outputs of the inverters 106 and 104, respectively, are turned off. The remaining two p-channel FETs of the selection circuit 108 are diode-connected FETs. When the inputs to the FETs (m4 and m5) are within a p-channel FET threshold voltage (VT) of each other and the control signal (menb_p) is low, the diode-connected FETs supply power to the output node. In this case, a voltage on the output node of the circuit 102 is one threshold voltage (VT) drop below the voltage level of the highest voltage source. In the case where the voltage sources (VDD and VPRG) are more than a p-channel FET threshold voltage (VT) drop apart, the p-channel FET (m4 or m5) with the lowest level input signal will be on (or at least weakly on). In this case, there would not be a p-channel FET threshold voltage (VT) drop from the highest voltage level to the output node.

It should be appreciated that the p-channel FET (m4 or m5) that supplies the output node is not fully on unless one of the input voltages is substantially at zero volts. The sense amplifier (including the inverters 104 and 106) ensures that one of the input signals provided to the gates of the FETs (m4 and m5) is substantially at zero volts. When the control signal (menb_p) goes high, the sense amplifier forces the lower input voltage to zero volts and the higher input voltage remains unchanged. The p-channel FET (m4 or m5) that receives zero volts at its control terminal (from the sense amplifier) supplies an associated supply voltage (i.e., the higher of the two supply voltages) to the output node. The p-channel FET that receives the higher input voltage from the sense amplifier turn offs and blocks the lower of the two supply voltages from the output node.

The diodes essentially keep the output node from floating when the input voltages are within a threshold voltage (VT) of each other and the control signal (menb_p) has not yet transitioned to a high level. It should be noted that at least one of the diodes may not be employed in the circuit 102. Using one diode (by removing either of the diode-connected FETs) still prevents the output node from floating. However, in this case, the output node may not be within one threshold voltage (VT) of the highest voltage level before the control signal (menb_p) goes high. In the worst case, the output node may be about two threshold voltage (VT) drops lower than the highest voltage level.

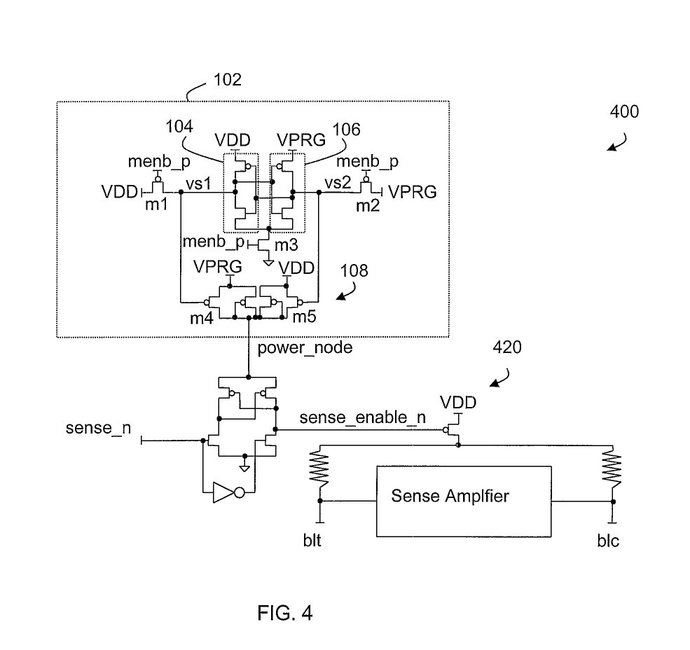

With reference to FIG. 4, a circuit 400 is depicted that also includes the voltage selection circuit 102, which operates in substantial conformance with the description above. As noted above, the circuit 102 is configured to determine which of two voltage sources (VDD and VPRG) has a higher voltage level and provide the selected voltage source with the higher voltage level at an output node (power_node). In a fuse testing operation mode (see signal diagram 600 of FIG. 6), the voltage source VPRG has a voltage level that is less than (typically greater than zero volts) a voltage level of the voltage source VDD. In this case, the circuit 102 provides the voltage source VDD on the output node to a fuse testing circuit 402. As is illustrated in FIG. 4, the fuse testing circuit 420 includes a level shifter that is coupled to the output node of the circuit 102.

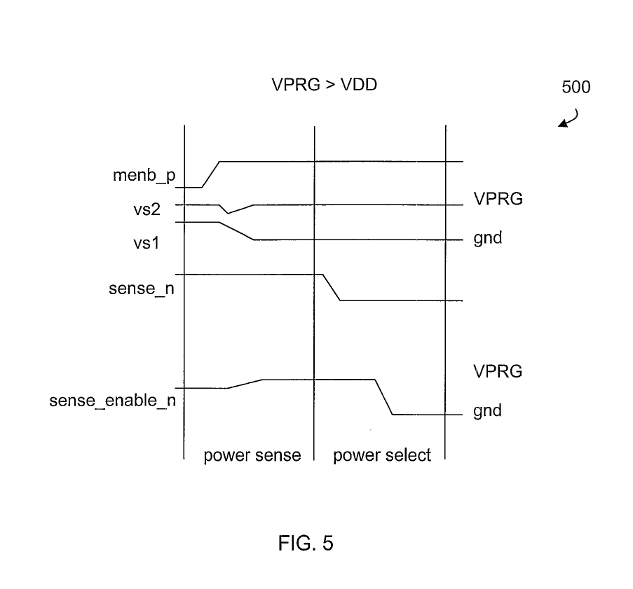

As noted above, and is also illustrated in FIG. 4, the first and second voltage sources (VDD and VPRG) are provided to respective inputs via the pass switches (m1 and m2) of the circuit 102. As previously mentioned, the pass switches (m1 and m2) are selectively controlled by a control signal (menb_p), which is used to set the inputs of the sense amplifier, which includes the cross-coupled inverters 106 and 104. With reference to FIG. 5, signal diagram 500 illustrates that when the control signal (menb_p) is high, a signal on signal line (sense_n) goes low, and a voltage level of the voltage source VPRG is greater than a voltage level of the voltage source VDD, signal vs1 goes low (e.g., to ground) and signal vs2 goes to the voltage level of the voltage source VPRG to provide the voltage source VPRG on the output node. Similarly, signal diagram 600 of FIG. 6 illustrates that when the control signal (menb_p) is high and a voltage level of the voltage source VDD is greater than a voltage level of the voltage source VPRG, the signal vs1 goes to VDD and the signal vs2 goes low (e.g., to ground) to provide VDD on the output node.

As noted above, the two cross-coupled inverters 104 and 106 are powered by different power supplies. The inverter 106 with VDD as its input utilizes VPRG as its supply and the inverter 104 with VPRG as its input utilizes VDD as its supply. In the disclosed embodiment, both of the inverters 104 and 106 share an n-channel FET footer (m3). When the control signal (menb_p) is in a high state, the pass switches (m1 and m2) are non-conductive and the footer (m3) conducts. When the footer (m3) is turned on, the cross-coupled inverters (106 and 104) are activated and the sense amplifier evaluates. In this case, an output of the cross-coupled inverter with the highest voltage supply provides a high level signal (corresponding to an associated supply level) on its output which turns off an associated one of p-channel FETs (m4 and m5) in selection circuit 108. An output of the cross-coupled inverter with the lower voltage supply provides a low level signal (e.g., ground) on its output which turns on an associated one of p-channel FETs (m5 and m4) in switch portion 108. Accordingly, techniques have been described herein for selecting a voltage source from multiple voltage sources. The techniques disclosed herein may be advantageously employed in various applications in which voltage levels of at least one voltage source change with operation modes.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” (and similar terms, such as includes, including, has, having, etc.) are open-ended when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

1. A method of operating a voltage selection circuit, comprising:
receiving a first voltage at an input of a first inverter of the voltage selection circuit, wherein the first inverter includes a first supply node coupled to a second voltage and a second supply node coupled to a common node;
receiving the second voltage at an input of a second inverter of the voltage selection circuit, wherein the second inverter includes a third supply node coupled to the first voltage and a fourth supply node coupled to the common node, wherein an output of the first inverter is coupled to the input of the second inverter and an output of the second inverter is coupled to the input of the first inverter;
providing one of the first and second voltages at an output node of the voltage selection circuit based on respective signal levels at the outputs of the first and second inverters;
selectively coupling the common node to a ground node; and
selectively coupling the first voltage to the input of the first inverter when the common node is not coupled to the ground node.

2. (canceled)

3. (canceled)

4. The method of claim 1, further comprising:
selectively coupling the second voltage to the input of the second inverter when the common node is not coupled to the ground node.

5. The method of claim 1, wherein the providing one of the first and second voltage sources at an output node based on respective signal levels at the outputs of the first and second inverters further comprises:
receiving, at a control terminal of a first switch, the respective signal level at the output of the first inverter, wherein the first switch is coupled between the second voltage and the output node;
receiving, at a control terminal of a second switch, the respective signal level at the output of the second inverter, wherein the second switch is coupled between the first voltage and the output node; and
coupling the second voltage to the output node with the first switch or the first voltage to the output node with the second switch based on which of the first and second voltages has a higher magnitude.

6. The method of claim 5, further comprising:
providing a first diode-coupled transistor in parallel with the first switch.

7. The method of claim 6, further comprising:
providing a second diode-coupled transistor in parallel with the second switch.

8. A voltage selection circuit, comprising:
a first inverter including an input coupled to a first voltage node, wherein the first inverter includes a first supply node coupled to a second voltage node and a second supply node coupled to a common node, and wherein the first voltage node is configured to receive a first voltage and the second voltage node is configured to receive a second voltage;
a second inverter including an input coupled to the second voltage node, wherein the second inverter includes a third supply node coupled to the first voltage node and a fourth supply node coupled to the common node, and wherein an output of the first inverter is coupled to the input of the second inverter and an output of the second inverter is coupled to the input of the first inverter;
a selection circuit including a first input coupled to the output of the second inverter and a second input coupled to the output of the first inverter, wherein the selection circuit is configured to couple one of the first and second voltage nodes to an output node based on signal levels at the outputs of the first and second inverters;
a first switch configured to selectively couple the common node to a ground node; and
a second switch configured to selectively couple the first voltage to the input of the first.

9. (canceled)

10. (canceled)

11. The voltage selection circuit of claim, further comprising:
a third switch configured to selectively couple the second voltage to the input of the second inverter when the common node is not coupled to the ground node.

12. The voltage selection circuit of claim 11, wherein the first switch is an n-channel metal-oxide semiconductor field-effect transistor and the second and third switches are p-channel metal-oxide semiconductor field-effect transistors.

13. The voltage selection circuit of claim 8, wherein the selection circuit further comprises:
a fourth switch including a control terminal, a first terminal, and a second terminal, wherein the control terminal of the fourth switch is coupled to the output of the second inverter, the first terminal of the fourth switch is coupled to the second voltage node, and the second terminal of the fourth switch is coupled to the output node; and
a fifth switch including a control terminal, a first terminal, and a second terminal, wherein the control terminal of the fifth switch is coupled to the output of the first inverter, the first terminal of the fifth switch is coupled to the first voltage node, and the second terminal of the fifth switch is coupled to the output node, and wherein the fourth switch is configured to couple the second voltage node to the output node when the second voltage is larger in magnitude than the first voltage and the fifth switch is configured to couple the first voltage node to the output node when the first voltage is larger in magnitude than the second voltage.

14. The voltage selection circuit of claim 13, further comprising: a first diode-coupled transistor coupled in parallel with the fourth switch.

15. The voltage selection circuit of claim 14, further comprising:
a second diode-coupled transistor coupled in parallel with the fifth switch.

16. The voltage selection circuit of claim 13, wherein the fourth and fifth switches are p-channel metal-oxide semiconductor field-effect transistors.

17. A voltage selection circuit, comprising:
a first inverter including an input coupled to a first voltage node, wherein the first inverter includes a first supply node coupled to a second voltage node and a second supply node coupled to a common node, and wherein first voltage node is configured to receive a first voltage and the second voltage node is configured to receive a second voltage;
a second inverter including an input coupled to the second voltage node, wherein the second inverter includes a third supply node coupled to the first voltage node and a fourth supply node coupled to the common node, and wherein an output of the first inverter is coupled to the input of the second inverter and an output of the second inverter is coupled to the input of the first inverter;
a first switch including a control terminal, a first terminal, and a second terminal, wherein the control terminal of the first switch is coupled to the output of the second inverter, the first terminal of the first switch is coupled to the second voltage node, and the second terminal of the first switch is coupled to an output node;
a second switch including a control terminal, a first terminal, and a second terminal, wherein the control terminal of the second switch is coupled to the output of the first inverter, the first terminal of the second switch is coupled to the first voltage node, and the second terminal of the second switch is coupled to the output node, and wherein the first switch is configured to couple the second voltage node to the output node when the second voltage is greater in magnitude than the first voltage and the second switch is configured to couple the first voltage node to the output node when the first voltage is greater in magnitude than the second voltage; and
a third switch configured to selectively couple the common node to a ground node.

18. (canceled)

19. The voltage selection circuit of claim 17, further comprising:
a fourth switch configured to selectively couple the first voltage node to the input of the first inverter when the common node is not coupled to the ground node.

20. The voltage selection circuit of claim 19, further comprising:
a fifth switch configured to selectively couple the second voltage node to the input of the second inverter when the common node is not coupled to the ground node.
